(19) United States
(12) Patent Application Publication
(10) Pub. No.: US 2008/0024438 A1
(43) Pub. Date: Jan. 31, 2008

(54) INTERFACING AN ELECTRONIC DEVICE TO A CONTROLLER

(75) Inventors: John Francis Collins, London (GB); Phillipe Georges Crispin, Buckinghamshire (GB); William Alan Galloway, Oxon (GB)

Correspondence Address: HARNESS, DICKEY & PIERCE, P.L.C., P.O. BOX 828, BLOOMFIELD HILLS, MI, 48303, US

(73) Assignee: ELEKSEN LIMITED, Buckinghamshire (GB)

(21) Appl. No.: 11/829,348

(22) Filed: Jul. 27, 2007

(30) Foreign Application Priority Data
Jul. 28, 2006 (GB) 06 14 999.1
Dec. 19, 2006 (GB) 06 25 238.1

(51) Int. Cl. G09G 5/00

(52) U.S. Cl. 345/156

(57) ABSTRACT

A method of interfacing an electronic device to a manually operable fabric controller forming part of a personal item, such as an item of clothing or bag. A set of interface devices, each comprising a housing enclosing a processing circuit with analogue ports and control ports, and supporting a first physical interface connected to analogue ports and connectable to a fabric sensor and a second physical interface connected to control ports and connectable to a specific type of electronic device. In this way, it is possible for different electronic devices to be controlled by operation of the fabric sensor supported by the personal item. A method of establishing a music-enabled item of clothing or bag. The identification of an appropriate interface device is facilitated at locations where electronic devices or accessories are made available. The fabric sensor may be removable from the personal item.

### CROSS REFERENCE TO RELATED APPLICATIONS

This application claims priority from United Kingdom Patent Application no. 06 14 999.1, filed 28 Jul. 2006 and from United Kingdom Patent Application no. 06 25 238.1, filed 19 Dec. 2006, the entire disclosures of which are incorporated herein by reference in their entirety.

### TECHNICAL FIELD

The present invention relates to interface apparatus and method of interfacing an electronic device to a manually operable fabric controller forming part of a personal item.

### BACKGROUND OF THE INVENTION

It is known for items of clothing and similar personal items, such as bags etc, to include fabric-based controls on outer surfaces so as to facilitate the control of electronic devices. In addition, it is also known for a plurality of different types and makes of electronic devices to be controlled in this way. A problem therefore arises in that for a range of items of clothing having a control device, many different electronic devices are available such that a problem exists in terms of including an appropriate interface device within the item of clothing so as to allow it to communicate with a plurality of available electronic devices.

### SUMMARY OF THE INVENTION

According to an aspect of the present invention, there is provided a method of interfacing an electronic device to a manually operable fabric controller forming part of a personal item, comprising the steps of: selecting an electronic device; identifying an appropriate interface device appropriate for the selected electronic device, from a set of interface devices, wherein each of said set of interface devices has a generic physical interface for connection to said fabric controller and a specific physical interface for connection to a specific type of electronic device; connecting the generic physical interface to said fabric controller; supporting the electronic device in a pocket in said personal item; connecting the specific physical interface to the electronic device; and controlling the electronic device in response to operation of the fabric controller, wherein the interface device has been programmed to supply appropriate control commands to the electronic device.

In an embodiment, the personal item is an item of clothing or a bag.

According to a second aspect of the present invention, there is provided a set of interface devices, each interface device comprising: a processing circuit with analogue ports and control ports; a housing, for enclosing said processing circuit and for supporting a first physical interface and a second physical interface; each interface device has a substantially similar first physical interface connected to said analogue ports and connectable to a fabric sensor forming part of a personal item, each interface device has a specific second physical interface connected to said control ports and connectable to a specific type of electronic device, such that when connected each interface device allows a specific type of electronic device to be controlled by the fabric sensor, and said set of interface devices includes interface devices having different specific second physical interfaces, such that said set of interface devices allows different specific types of electronic device to be controlled by the fabric sensor of said personal item.

A set of interface devices wherein the processing circuit of each interface device is a programmable micro-controller.

According to a further aspect of the present invention, there is provided a method of establishing a music-enabled item of clothing or bag, wherein an item of clothing or bag is chosen from a collection of controller enabled items of clothing or bags, each of said controller enabled item of clothing or bag having a fabric position sensor included therein with a generic electrical connector; comprising the steps of: selecting an electronic music player and inserting said music player into a pocket of said item of clothing or bag, wherein said pocket also has a connection to ear-pieces; identifying an appropriate interface device appropriate for the selected electronic device, from a set of interface devices; connecting a generic interface of said interface device to said generic electrical connector; connecting a specific interface of said interface device to said electronic device; and controlling the selected music player in response to applying manual pressure to the fabric position sensor of the chosen item of clothing or bag.

A method wherein the identification of an appropriate interface device is facilitated at locations that permit the selection of an electronic music player.

### BRIEF DESCRIPTION OF THE DRAWINGS

FIG. 1 shows an interface device;

FIG. 2 shows internal components of the interface device shown in FIG. 1;

FIG. 3 shows the selection of an electronic device;

FIG. 4 illustrates the selection of a jacket having fabric controls;

FIG. 5 illustrates the selection of appropriate interface device;

FIG. 6 details the jacket identified in FIG. 4;

FIG. 7 shows a jacket of FIG. 6 having an interface device located therein;

FIG. 8 shows a jacket of FIG. 7 in which the interface device has been connected to an electronic device;

FIG. 9 shows the jacket of FIG. 8 having an additional electronic device located therein;

FIG. 10 illustrates the jacket of FIG. 9 in use;

FIG. 11 illustrates the selection of a pair of jeans having fabric controls;

FIG. 12 details the pair of jeans identified in FIG. 11;

FIG. 13 shows the pair of jeans of FIG. 12 having an interface device located therein;

FIG. 14 shows the pair of jeans of FIG. 13 in which the interface device has been connected to an electronic device;

FIG. 15 shows the pair of jeans of FIG. 14 having an additional electronic device located therein;

FIG. 16 illustrates the pair of jeans of FIG. 15 in use;

FIG. 17 shows an alternative pair of jeans having fabric controls, and

FIG. 18 illustrates a rucksack having fabric controls.

### DETAILED DESCRIPTION

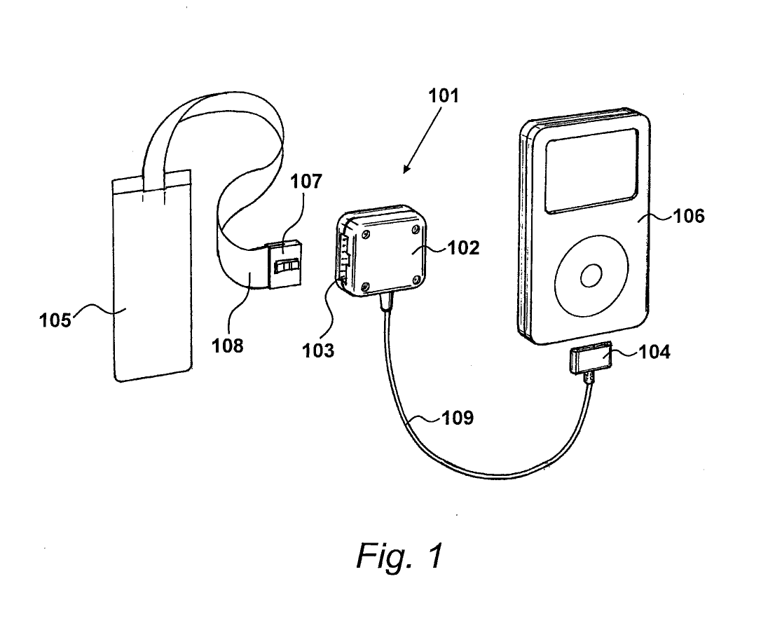

### FIG. 1

An interface device 101 is shown in FIG. 1, having a processing circuit with analogue ports and control ports. The processing circuit includes a housing 102, for enclosing the processing circuit, and for supporting a first physical interface 103 and a second physical interface 104. The first physical interface 102 is connected to the analogue ports of the processing circuit and is also connectable to a fabric sensor 105. The second physical interface 104 is connected to the control ports of the processing circuit and is also connectable to an electronic device, such as audio player 106, such that when an electronic device is connected to the interface device 101 (and assuming that the interface device has been connected to a fabric sensor 105), it is possible for the electronic device 106 to be controlled by manual operation of the fabric sensor 105.

As shown in the example of FIG. 1, it is possible for the first physical interface to take the form of a socket 103 into which a plug 107 is received; the plug itself receiving connections 108 from the fabric sensor 105.

As illustrated in FIG. 1, the second physical interface may take the form of a cable 109 that extends from the housing 102 so as to be connected to a plug 104 insertable into the electronic device 106.

In an embodiment, the electronic device is a personal music player in which the output level of played music is controllable and the interface apparatus is configured to facilitate the control of the output level by a manual stroking action of the fabric sensor 105. In an embodiment, other operations such as the starting and stopping of a track, are performable by the music player 106 and the interface device 101 is configured to facilitate the control of these other operations by being responsive to manual pressure applied to specific regions of the fabric sensor 105.

In an alternative embodiment, the electronic device takes the form of a mobile telephone, possibly having the facility to play recorded audio signals. Presently, the format for these audio signals is often that designated as .mp3 but it should be appreciated that other formats may be used.

In an alternative embodiment, the interface device 101 is configured to communicate with a mobile telephone over a local wireless connection wherein, in response to an incoming telephone call, an audio player, connected to interface 104 say, is controlled by the interface apparatus so as to modify audio output.

In an embodiment, the fabric sensor 105 forms part of a manufactured item, usually a manufactured item that would be worn by a person or carried by a person. In particular the manufactured item is in local proximity to the person so that the person can make use of the electronic device, possibly an audio player or a mobile telephone.

In an embodiment disclosed herein, the manufactured item takes the form of a personal item in the form of a jacket, possibly a jacket used for outdoor activities including skiing and skateboarding etc. In another embodiment disclosed herein, the personal item is a pair of jeans. However, it should be appreciated that the interface device is applicable to other items of clothing, for example a pair of trousers, a skirt or a shirt, and to other items, such as bags etc.

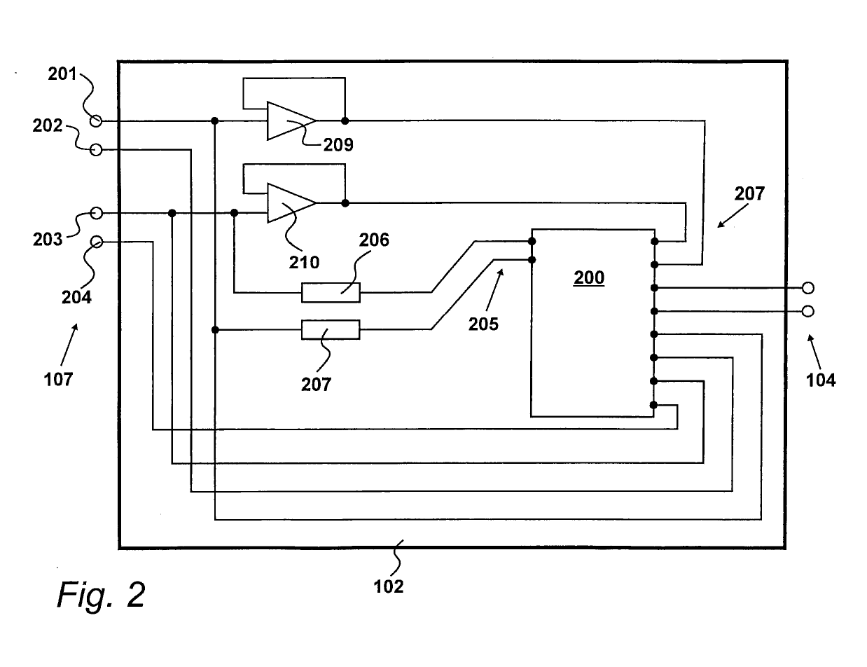

### FIG. 2

Internal components of the interface device 101 are illustrated in FIG. 2. Interface 107 is shown extending from the housing 102 as connection to the left and interface 104 is shown as connections extending from the right of housing 102. It should be appreciated that the number of connections establishing interface 104 will vary depending on the particular application.

A processor 200 (preferably a programmable micro-controller) supplies voltages to connectors 201 to 204 (of interface 107). Resistors 206 and 207 have resistances that are substantially similar to the resistance of the fabric detector, measured from a first conducting layer to the other conducting layer when a typical target pressure has been applied.

A detection process is controlled by a program executed by the micro-controller 200 that is in turn configured to supply output voltages at pins 205 and to receive analogue voltages at input pins 207 via high impedance buffers 209 and 210.

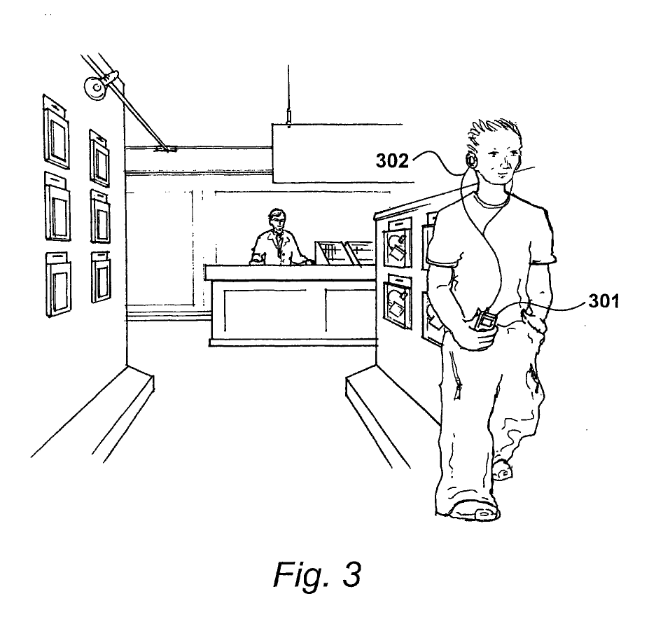

### FIG. 3

It can be appreciated that it is possible to design an item of clothing such that appropriate interface devices are provided to facilitate its connection to various electronic devices. However, this creates a problem in that many different types of electronic device are available on the market at any particular point in time. Furthermore, it is also appreciated that the life cycles of electronic devices tend to be relatively shorter than that of items of clothing or other apparel. Furthermore, it is also appreciated that the addition of electronic components could add significantly to the overall cost of these items and thereby dissuade users of both electronic devices (possibly audio players) and a jacket or a pair of jeans say, from achieving the benefits of having an integrated system so as to facilitate the playing of the device while wearing the jacket or pair of jeans.

The interface device described herein provides a solution to this dilemma in that it is possible to allow many types of items of clothing to communicate with many types of electronic devices by the provision of a plurality of appropriately designed interface devices. Furthermore, it is appreciated that an approach of this type would appear more attractive to users by placing the electronic interface components within the realm of the electronic device purchase, rather than within the realm of the apparel purchase.

It is therefore envisaged that a user wishes to establish an environment substantially similar to that shown in FIG. 1. Thus, the user, in this example, is purchasing a jacket having a fabric sensor 105 with an appropriately designed plug 107. This plug 107 connects to the socket 103 of an interface device 101 in a generic way. That is to say, each of a plurality of interface devices 101 includes a first physical interface 103 of substantially similar design allowing it to connect with any plug 107 found within any jacket of the set.

A plurality of interface devices 101 are provided, each with different communication sockets 104, and with each of these sockets being configured to interface with a particular type of electronic device. That is to say, each of a plurality of interface devices 101 includes a specific second physical interface 104 allowing it to connect with a specific type of electronic device. Furthermore, control software contained within the interface device 101, and executable upon the micro-controller detailed in FIG. 2, could be specifically configured to provide appropriate control signals to the electronic device concerned. Thus, the plurality of interface devices 101 allows the fabric sensor 105 to be connected to different types of electronic device.

It is envisaged that users would often purchase the electronic device first. As shown in FIG. 3, a typical user has purchased an mp3 player from a retail outlet specialising in products of this type. The mp3 player 301 is fully functional and in response to manual operations applied to the player itself, it is possible for selected audio tracks to be supplied to a user via a headset 302 that flexes freely in front of a user. Similarly, in an alternative configuration, it will be possible for the user to support the mp3 player 301 in a pocket, from a belt attachment or from a lanyard. In an alternative embodiment, audio signals are supplied to a head-set by wireless communication, such as in accordance with the Bluetooth protocol.

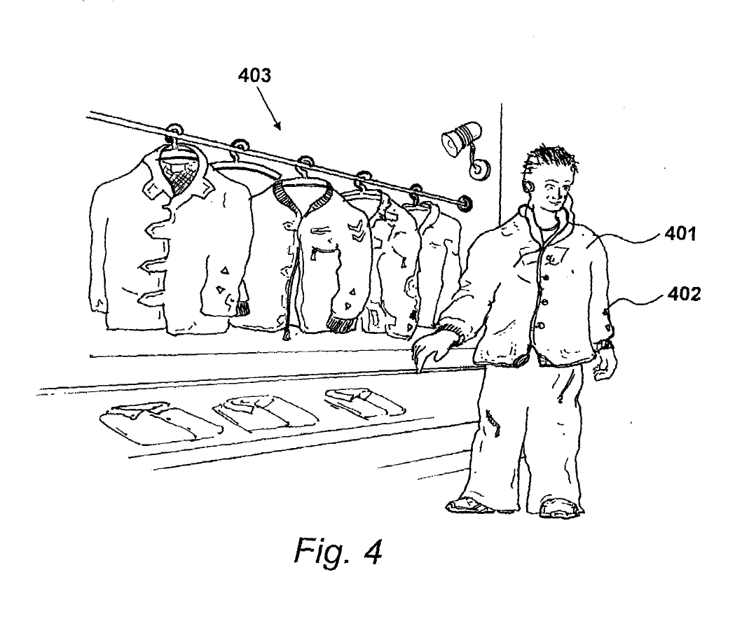

### FIG. 4

It is envisaged that the majority of items of apparel that have fabric sensors for effecting the control of electronic devices would themselves be purchased from retail outlets generally selling related items of clothing. As illustrated in FIG. 4, our user has purchased a fabric sensor enabled jacket 401 having a fabric sensor built into the sleeve of the jacket such that manually operable controls 402 are visible on said sleeve. When purchasing this jacket, it is noted that a plurality of alternative designs, illustrated generally at 403, is available. Each of these jackets includes a fabric sensor substantially of the type illustrated at 105. As previously described, our user has purchased, from an electronics outlet, an audio player substantially similar to that shown at 106. However, presently, it is not possible to connect these together because an appropriate interface device 101 is required.

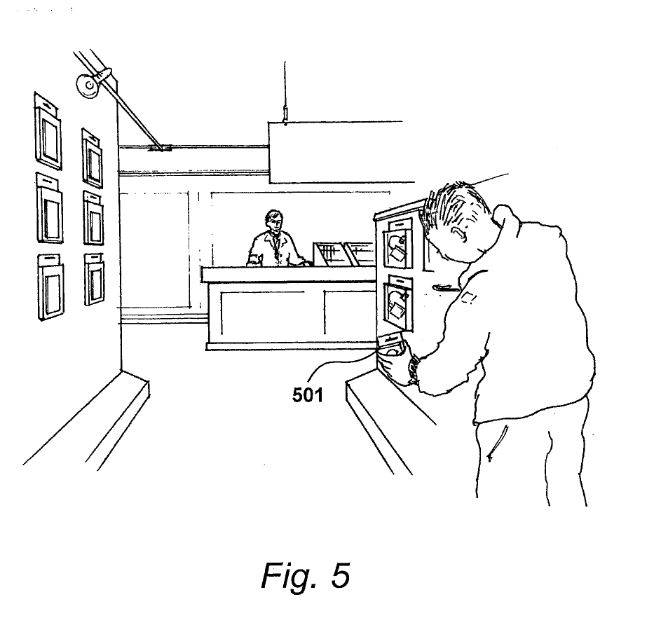

### FIG. 5

As illustrated in FIG. 5, a user may return to an appropriate retail outlet, possibly the same one from where the original mp3 player was purchased, to purchase an appropriate interface 501 which allows the generic jacket based connector 107 to be interfaced to the previously purchased audio player, as illustrated in FIG. 3. Alternatively, an interface could be provided to a mobile telephone, possibly with audio playback facility, whereupon it is likely that the interface device would be purchased from the purveyor of mobile telephones or mobile telephone accessories.

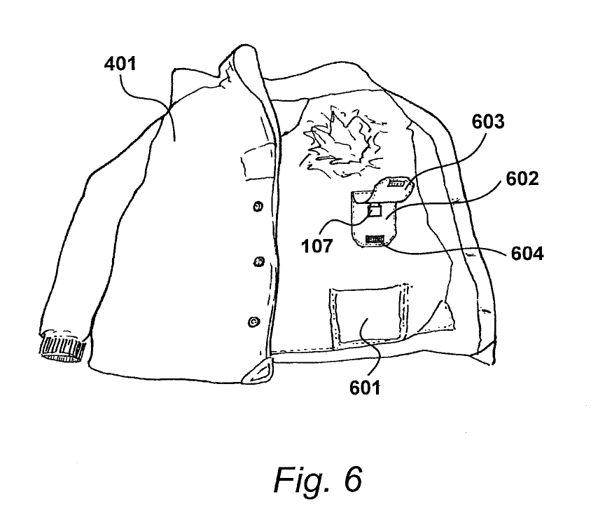

### FIG. 6

The jacket 401 identified in FIG. 4 is shown in FIG. 6, in which the left side of the jacket is open. This reveals a pocket 601 for receiving an electronic device, such as that shown in FIG. 3 and a pouch 602 for receiving the interface device, of the type shown in FIG. 1. The pouch 602 includes a flap 603 that is secured by Velcro™ 604, or alternative securing devices. With the flap 603 in its elevated position, as shown in FIG. 6, plug 107 is visible; the remainder of the fabric sensor being restrained within the internal membranes of the jacket.

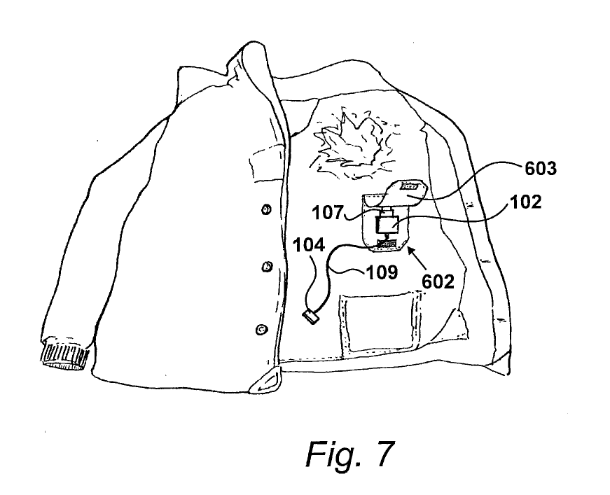

### FIG. 7

As illustrated in FIG. 7, the housing 102 of the interface device 101 is located within the pouch 602 such that plug 107 is located within the generic interface socket 103. Thereafter, flap 603 is secured while cable 109 extends below the pouch. In this configuration, second physical interface 104 is free and at this point the audio player 301 (or alternative electronic device) is attached to the interface device 101. As previously described, specific interface 104 is purposefully designed to connect to the selected audio player 301, having being selected from a plurality of similar available devices.

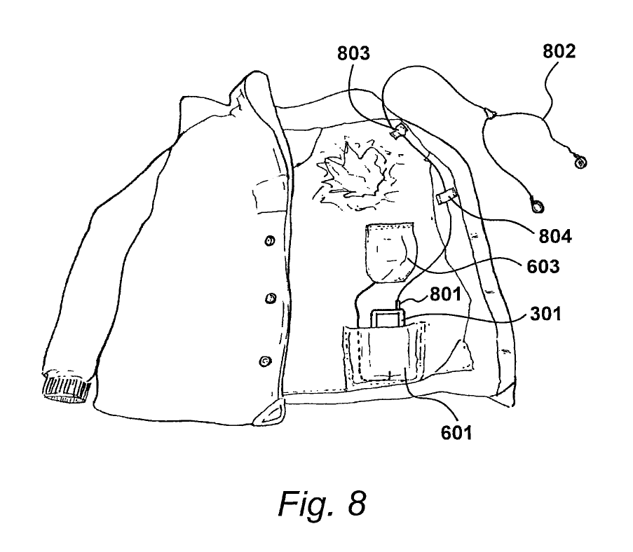

### FIG. 8

Having connected specific interface 104 to the audio player, the audio player is secured within pocket 601, as illustrated in FIG. 8. A socket 801 of an audio headset 802 is connected to the audio player and it should be appreciated that the headset 802 and its connection will have been obtained with the audio player or obtained separately; the jacket or the interface device 101 do not need to be specifically adapted for a particular type of audio headset. However, the jacket is provided with a first loop 803 and a second loop 804 so as to restrain the cable of the headset and to facilitate operation. Thus, in the configuration shown in FIG. 8, it is now possible to play audio recordings while wearing the jacket and to control audio player 301 by manual operation of the sleeve controls 402.

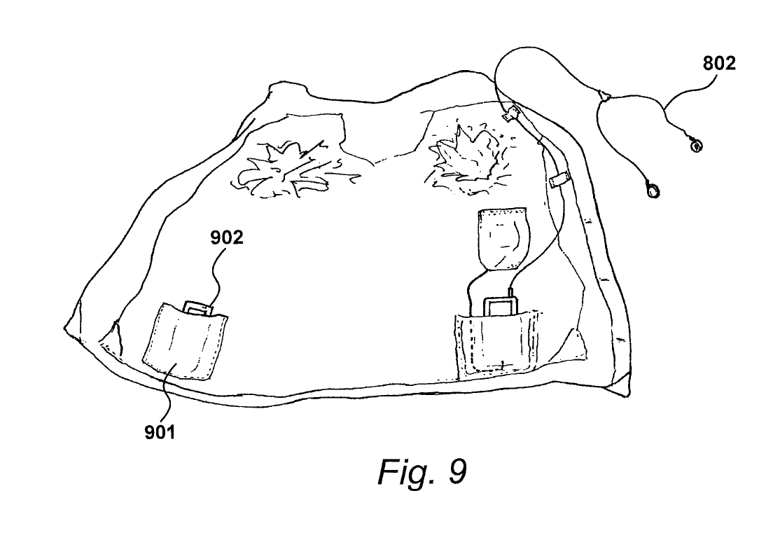

### FIG. 9

The jacket shown in FIG. 9 is substantially similar to that shown in FIG. 8. The right side of the jacket is also shown open and reveals a second pocket 901 for receiving a mobile cellular telephone 902. In this preferred embodiment, the mobile cellular telephone 902 and the interface device are arranged to communicate by short range radio signals, such as that provided by the Bluetooth, or other wireless protocols. Thus, while playing an audio program, it is possible for the interface device to respond to an incoming telephone call such that audio signals are suppressed and audio signals received from the mobile telephone are supplied to the user's headset 802. Furthermore, in some preferred embodiments, it is possible for attributes of the mobile telephone, such as volume and replace hook etc to be controlled by manual operation of controls 402.

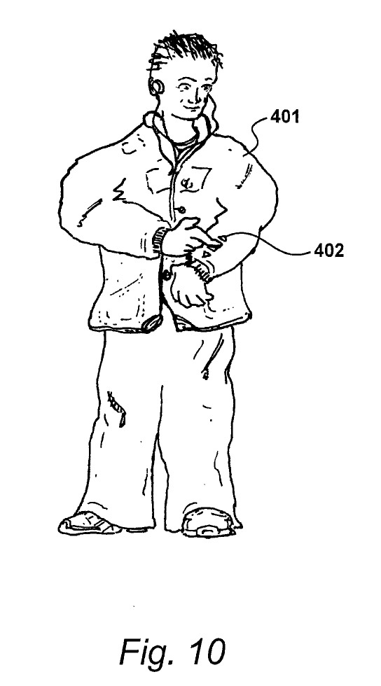

### FIG. 10

Thus, as shown in FIG. 10, it is possible for a user to adjust the operation of an audio device and the operation of a mobile telephone using controls 402 mounted on the outside of a jacket 401. In an alternative embodiment, similar functionality is provided by a mobile telephone having audio playback facilities. Alternatively, other items of clothing may be used or the control and location of devices may be placed in a storage item, such as a bag or a rucksack.

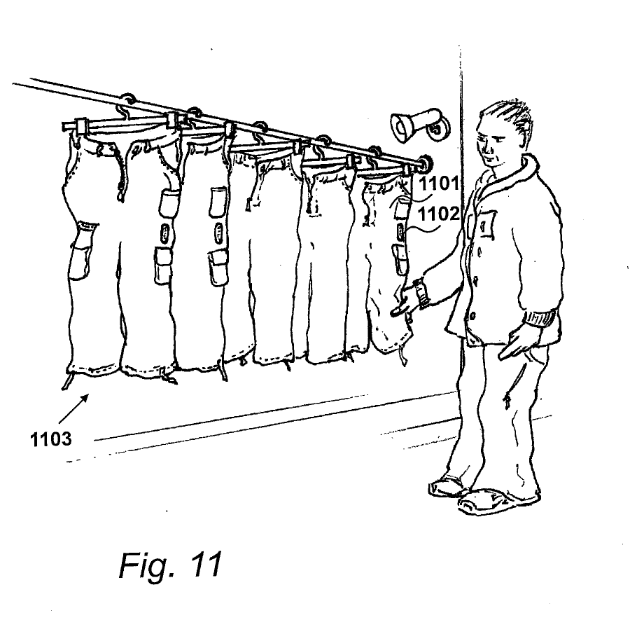

### FIG. 11

As illustrated in FIG. 11, our user is selecting for purchase a fabric sensor enabled pair of jeans 1101 having a fabric sensor built into the jeans such that manually operable controls 1102 are visible on one leg, for example being presented in the thigh area when worn. When purchasing these jeans, it is noted that a plurality of alternative designs, illustrated generally at 1103, that each support a fabric sensor substantially of the type illustrated at 105 may be made available.

As previously described, our user has purchased, from an electronics outlet, an audio player substantially similar to that shown at 106 in FIG. 1. Our user may return to an appropriate retail outlet, possibly the same one from where the electronic device was purchased, to purchase an appropriate interface that allows the jeans based fabric sensor to be interfaced to the previously purchased audio player, as illustrated in FIG. 3.

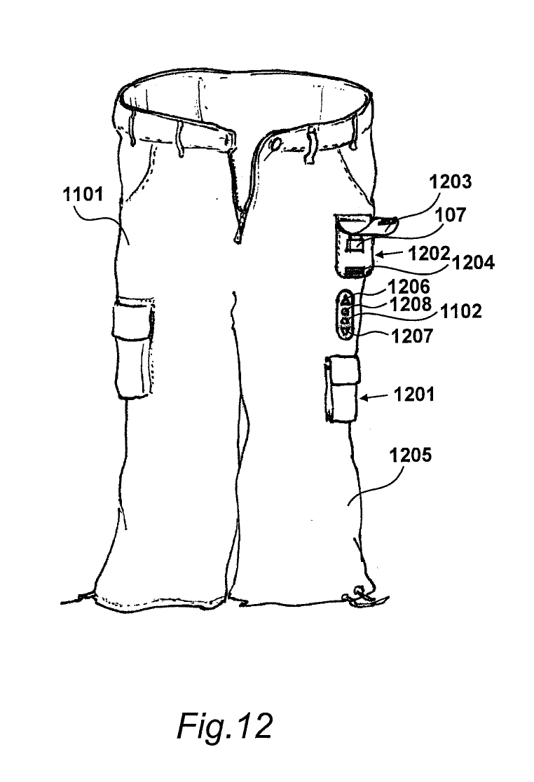

### FIG. 12

The jeans 1101 identified in FIG. 11 are shown in FIG. 12. A pocket 1201 is provided for receiving an electronic device, such as that shown in FIG. 3, and a pouch 1202 is provided for receiving the interface device, of the type shown in FIG. 1. Pouch 1202 includes a flap 1203 that is secured by Velcro™ 1204, or alternative securing devices. With the flap 1203 in its elevated position, as shown in FIG. 12, plug 107 is visible; the remainder of the fabric sensor being restrained within the construction of the pair of jeans.

Manually operable controls 1102 are presented on a leg 1105 of the jeans 1101, which in this example is the left leg but may alternatively be the right leg.

The manually operable controls 1102 include graphical representations to indicate that the fabric sensor is responsive to manually applied pressure, in the present example responsive to gestures and manually applied presses. For example, arrows 1206 and 1207 pointing in opposite directions are displayed to represent that the fabric sensor is responsive to a stroking action in the direction of an arrow. The user may be directed to use this action to control the level of audio output. Symbols, such as circle 1208, are presented to indicate specific regions responsive to manually applied presses. The user may be directed to use this action to select an audio track to be played.

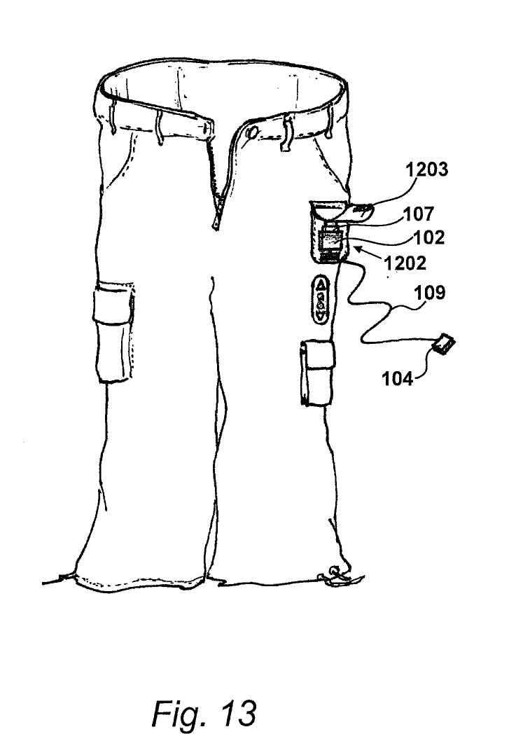

### FIG. 13

As illustrated in FIG. 13, the housing 102 of the interface device is located within the pouch 1202 such that plug 107 is located within socket 103. Thereafter, flap 1203 is secured while cable 109 extends below the pocket. In this configuration, interface 104 is free and at this point the audio player (or alternative electronic device) is attached to the interface device 104. As previously described, interface 104 is purposefully designed to connect to the selected audio player, having being selected from a plurality of similar available devices.

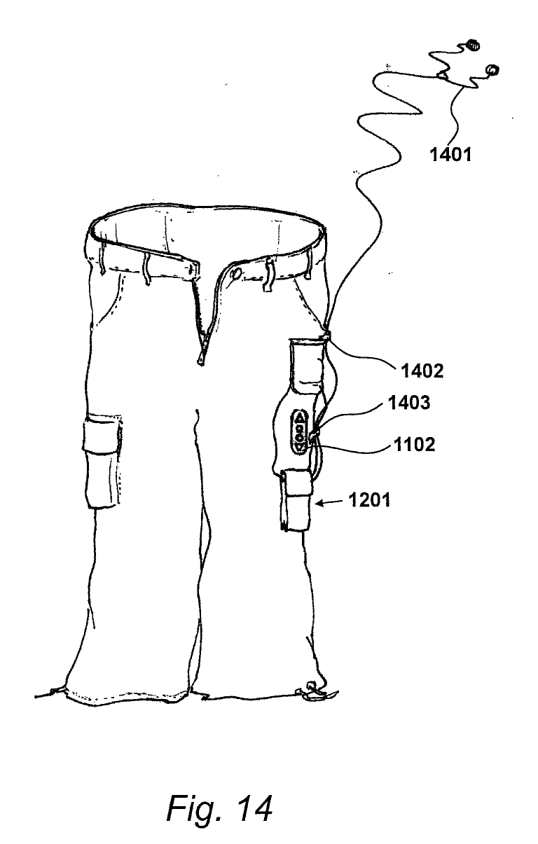

### FIG. 14

Having connected interface 104 to the audio player, the audio player is secured within pocket 1201, as illustrated in FIG. 14. A socket of an audio headset 1401 is connected to the audio player and it should be appreciated that the headset 1401 and its connection will have been obtained with the audio player or obtained separately; the jeans or the interface device 101 do not need to be specifically adapted for a particular type of audio headset. However, the pair of jeans is provided with a first loop 1402 and a second loop 1403 so as to restrain the cable of the headset and to facilitate operation. Thus, in the configuration shown in FIG. 14, it is now possible to play audio recordings while wearing the jeans and to control the audio player by manual operation of the leg controls 1102.

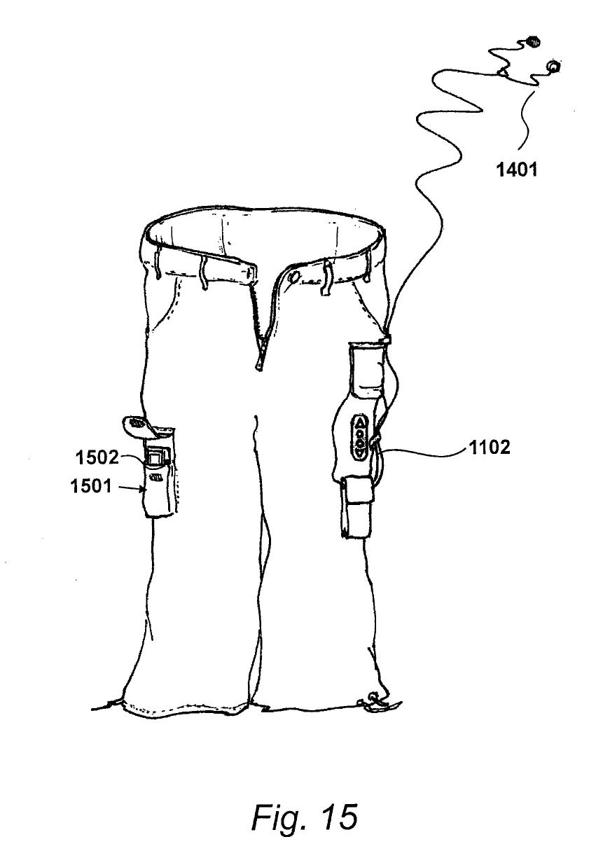

### FIG. 15

The pair of jeans shown in FIG. 15 is substantially similar to that shown in FIG. 14. The opposite, in this example the right, leg of the jeans is provided with a pocket 1501 for receiving a mobile cellular telephone 1502. In this preferred embodiment, the mobile cellular telephone 1502 and the interface device 101 are arranged to communicate by short range radio signals, such as that provided by the Bluetooth, or other wireless protocols. Thus, while playing an audio program, it is possible for the interface device to respond to an incoming telephone call such that audio signals are suppressed and audio signals received from the mobile telephone are supplied to the user's headset 1501. Furthermore, in some preferred embodiments, it is possible for attributes of the mobile telephone, such as volume and replace hook etc to be controlled by manual operation of controls 1102.

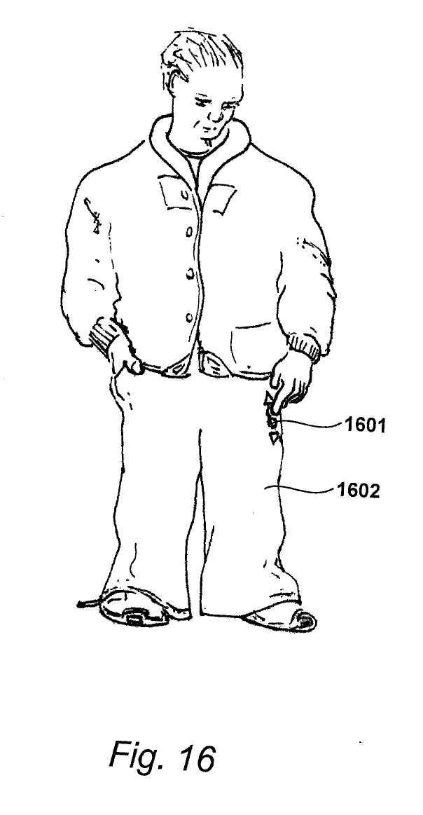

### FIG. 16

Thus, as illustrated in FIG. 16, it is possible for a user to adjust the operation of an audio device and the operation of a mobile telephone using controls 1601, such as controls of the type of controls 1102, mounted on the outside of a pair of jeans 1602. In an alternative embodiment, similar functionality is provided by a mobile telephone having audio playback facilities. Alternatively, other items of clothing may be used or the control and location of devices may be placed in a storage item, such as a bag or a rucksack.

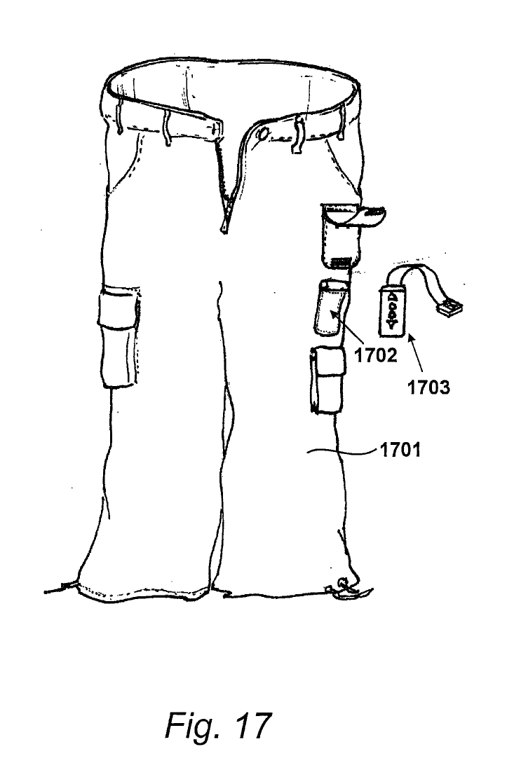

### FIG. 17

In the embodiment shown in FIG. 17, a pair of jeans 1701 includes a pocket 1702 for receiving a removable subassembly 1703 that includes the fabric sensor and associated cable. The jeans 1701 hence support the subassembly 1703 when received by pocket 1702.

A moulded rubber housing for a socket or other connector may be included in the subassembly pocket 1702; this may be sewn or otherwise secured therein.

Alternative or additional subassembly securing means may be provided to enable the removable fabric sensor to be releasably supported by the personal item.

In this example, a user may choose for the fabric sensor to be supported by the jeans 1701 for operation, and then choose for the fabric sensor to be unsupported by the jeans 1701 prior to or following operation.

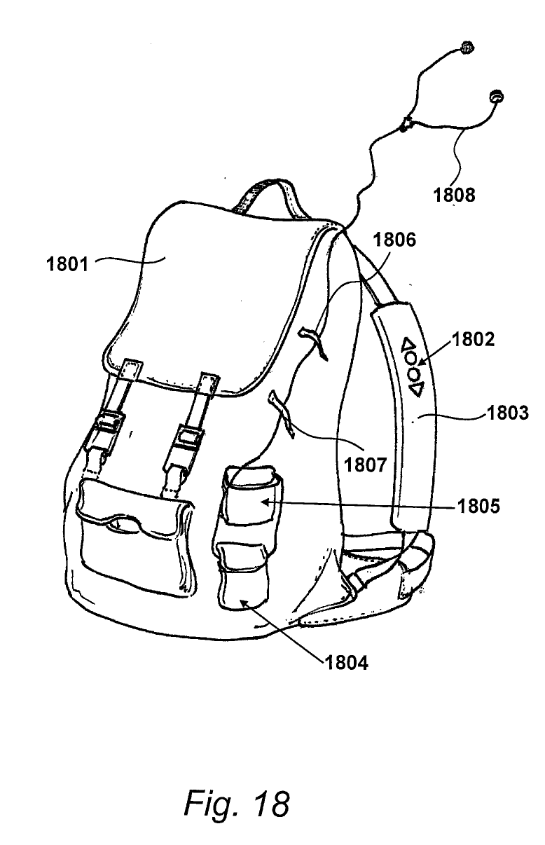

### FIG. 18

FIG. 18 shows a fabric sensor enabled bag, in the form of a rucksack 1801. In this example, manually operable controls 1802 are presented on one strap 1803. The rucksack 1801 is provided with a pocket 1804 for an electronic device, a pocket 1805 for an interface device, and loops 1806, 1807 for the cable of audio ear-pieces 1808.

It is to be appreciated that the physical arrangement of pockets and securing means provided for various electronic devices, the interface apparatus, fabric sensor and associated cables and connectors may vary between different applications.

What is claimed is:

1. A method of interfacing an electronic device to a manually operable fabric controller forming part of a personal item, comprising the steps of:
selecting an electronic device;
identifying an appropriate interface device appropriate for the selected electronic device, from a set of interface devices, wherein each of said set of interface devices has a generic physical interface for connection to said fabric controller and a specific physical interface for connection to a specific type of electronic device;
connecting the generic physical interface to said fabric controller;
supporting the electronic device in a pocket in said personal item;
connecting the specific physical interface to the electronic device; and
controlling the electronic device in response to operation of the fabric controller, wherein the interface device has been programmed to supply appropriate control commands to the electronic device.

2. A method according to claim 1, wherein said personal item is an item of clothing or a bag.

3. A method according to claim 2, wherein said electronic device is a music player.

4. A method according to claim 3, including the step of connecting ear-pieces that are supported within said item of clothing or bag, to said music player.

5. A method according to claim 3, further comprising the steps of establishing a local wireless connection between the interface apparatus and a mobile telephone, wherein the interface device is configured to modify the operation of the music player in response to receiving an incoming telephone call.

6. A method according to claim 1, wherein the identification of an appropriate interface device is facilitated at locations that permit the selection of said electronic device.

7. A method according to claim 2, wherein said personal item is a jacket.

8. A method according to claim 7, wherein said fabric controller is constructed within a sleeve of said jacket.

9. A method according to claim 2, wherein said personal item is a pair of jeans.

10. A method according to claim 9, wherein said fabric controller is constructed within a leg of said pair of jeans.

11. A method according to claim 1, wherein said fabric controller is removable from said personal item.

12. A set of interface devices, each interface device comprising:
a processing circuit with analogue ports and control ports;
a housing, for enclosing said processing circuit and for supporting a first physical interface and a second physical interface;
each interface device has a substantially similar first physical interface connected to said analogue ports and connectable to a fabric sensor forming part of a personal item,
each interface device has a specific second physical interface connected to said control ports and connectable to a specific type of electronic device, such that when connected each interface device allows a specific type of electronic device to be controlled by the fabric sensor, and
said set of interface devices includes interface devices having different specific second physical interfaces, such that said set of interface devices allows different specific types of electronic device to be controlled by the fabric sensor of said personal item.

13. A set of interface devices according to claim 12, wherein said personal item is an item of clothing or a bag.

14. A set of interface devices according to claim 12, wherein said processing circuit is a programmable micro-controller.

15. A set of interface devices according to claim 12, wherein said first physical interface takes the form of a socket into which a plug is received, in which said plug receives connections from said fabric sensor.

16. A set of interface devices according to claim 12, wherein said second physical interface takes the form of a cable extending from said housing, wherein a plug insertable into said electronic device is attached to said cable.

17. A method of establishing a music-enabled item of clothing or bag, wherein an item of clothing or bag is chosen from a collection of controller enabled items of clothing or bags, each of said controller enabled item of clothing or bag having a fabric position sensor included therein with a generic electrical connector; comprising the steps of:
selecting an electronic music player and inserting said music player into a pocket of said item of clothing or bag, wherein said pocket also has a connection to ear-pieces;
identifying an appropriate interface device appropriate for the selected electronic device, from a set of interface devices;
connecting a generic interface of said interface device to said generic electrical connector;
connecting a specific interface of said interface device to said electronic device; and
controlling the selected music player in response to applying manual pressure to the fabric position sensor of the chosen item of clothing or bag.

18. A method according to claim 17, wherein the identification of an appropriate interface device is facilitated at locations that permit the selection of an electronic music player.

19. A method according to claim 17, wherein the identification of an appropriate interface device is facilitated at locations where mobile telephone accessories are made available.

20. A method according to claim 17, wherein the output level of played music is controllable and the interface device is configured to facilitate the control of said output level by manual stroking of the fabric sensor.

21. A method according to claim 20, wherein other operations such as the starting and the stopping of a track are performable by the music player and the interface device is configured to facilitate the control of these other operations by being responsive to manual pressure applied to specific regions of said fabric sensor.

22. A method according to claim 17, wherein the interface device is also configured to communicate with a mobile telephone over a local wireless connection, wherein in response to an incoming call, the audio player is controlled by the interface apparatus so as to modify audio output.
